(19) United States
(12) Patent Application Publication
(10) Pub. No.: US 2022/0387993 A1
(43) Pub. Date: Dec. 8, 2022

(54) ACTIVE SURFACE DEVICES FOR AND METHODS OF PROVIDING DRIED REAGENTS IN MICROFLUIDIC APPLICATIONS

(71) Applicants: Redbud Labs, Inc., Research Triangle Park, NC (US); THE UNIVERSITY OF NORTH CAROLINA AT CHAPEL HILL, Chapel Hill, NC (US)

(72) Inventors: Richard Chasen Spero, Research Triangle Park, NC (US); Jay Kenneth Fisher, Research Triangle Park, NC (US); Richard Superfine, Chapel Hill, NC (US)

(73) Assignees: Redbud Labs, Inc., Research Triangle Park, NC (US); THE UNIVERSITY OF NORTH CAROLINA AT CHAPEL HILL, Chapel Hill, NC (US)

(21) Appl. No.: 17/773,345

(22) PCT Filed: Nov. 2, 2020
(86) PCT No.: PCT/US2020/058524

§ 371 Date: Apr. 29, 2022

Related U.S. Application Data
(60) Provisional application No. 62/929,644, filed on Nov. 1, 2019.

(51) Int. Cl. B01L 3/00; B01L 9/00

(52) U.S. Cl. CPC B01L 3/50273; B01L 9/527; B01L 2200/16; B01L 2400/0677

(57) ABSTRACT

Active surface devices for and methods of providing dried reagents in microfluidic applications is disclosed. In one example, the active surface devices include one or more dried reagent spots in relation to an active surface in the reaction (or assay) chamber thereof. In another example, the active surface devices include a dried reagent coating on the surfaces of the reaction (or assay) chamber including the active surface. In one example, the presently disclosed active surface devices are micropost-based active surface devices for providing active mixing therein. Further, a method of forming a dried reagent spot in the active surface devices is provided. Further, a method of forming a dried reagent coating in the active surface devices is provided. Further, a method of using the active surface devices for providing dried reagents in microfluidic applications is provided.

### RELATED APPLICATIONS

The presently disclosed subject matter is related and claims priority to U.S. Provisional Patent Application No. 62/929,644, entitled “ACTIVE SURFACE DEVICES FOR AND METHODS OF PROVIDING DRIED REAGENTS IN MICROFLUIDIC APPLICATIONS,” filed on Nov. 1, 2019; the entire disclosure of which is incorporated herein by reference.

This disclosure is related to U.S. Pat. No. 9,238,869, entitled “Methods and Systems for Using Actuated Surface-Attached Posts for Assessing Biofluid Rheology,” issued on Jan. 19, 2016; U.S. Patent App. No. 62/522,536, entitled “Modular Active Surface Devices for Microfluidic Systems and Methods of Making Same,” filed on Jun. 20, 2017; and U.S. Patent App. No. 62/654,048, entitled “Magnetic-Based Actuation Mechanisms for and Methods of Actuating Magnetically Responsive Microposts in a Reaction Chamber,” filed on Apr. 16, 2018; the entire disclosures of which are incorporated herein by reference.

### TECHNICAL FIELD OF THE INVENTION

The presently disclosed subject matter relates generally to the processing of biological materials and more particularly to active surface devices for and methods of providing dried reagents in microfluidic applications.

### BACKGROUND

Microfluidic devices can include one or more active surfaces, which can be, for example, surface-attached microposts in a reaction chamber that are used for capturing target analytes in a biological fluid. Exemplary microfluidic devices include those described in U.S. Pat. Nos. 9,238,869 and 9,612,185, both entitled “Methods and Systems for Using Actuated Surface-Attached Posts for Assessing Biofluid Rheology,” which are directed to methods, systems, and computer readable media for using actuated surface-attached posts for assessing biofluid rheology. According to one aspect, a method for testing properties of a biofluid specimen includes placing the specimen onto a micropost array having a plurality of microposts extending outwards from a substrate, wherein each micropost includes a proximal end attached to the substrate and a distal end opposite the proximal end, and generating an actuation force in proximity to the micropost array to actuate the microposts, thereby compelling at least some of the microposts to exhibit motion. The method further includes measuring the motion of at least one of the microposts in response to the actuation force and determining a property of the specimen based on the measured motion of the at least one micropost.

In microfluidic consumable devices there is a need to store dried reagents. However, certain drawbacks exist with respect to providing dried reagents in microfluidic devices. For example, current methods of drying and loading reagents into microfluidic cartridges are expensive and/or inconvenient. Additionally, there may be challenges with respect to maintaining shelf stability of dried reagents in microfluidic devices. For example, it may be difficult to maintain complete isolation of dried reagents from sources of liquid (e.g., wet blister packs) that may exist elsewhere on the cartridge. Further, there may be certain challenges with respect to the use of dried reagents in microfluidic devices. For example, when dried reagents resuspend, they often don't resuspend homogeneously. Additionally, once resuspended, there is often a need to mix continuously while the reaction is occurring, adding complexity and cost to microfluidic devices.

### SUMMARY

To address the foregoing problems, in whole or in part, and/or other problems that may have been observed by persons skilled in the art, the present disclosure provides compositions and methods as described by way of example as set forth below.

The invention provides a microfluidic reaction chamber. The microfluidic reaction chamber may include a housing enclosing a chamber. The microfluidic reaction chamber may include an active surface situated in the chamber, wherein the active surface may include a dried reagent deposited thereon. The microfluidic reaction chamber may include an opening suitable for flowing a liquid into and/or out of the microfluidic reaction chamber.

In certain embodiments of the invention, the microfluidic reaction chamber may have a volume in the range of about 0.5 μL to about 500 μL.

In certain embodiments of the invention, the active surface may comprise a micropost active surface layer.

In certain embodiments of the invention, the dried reagent may comprise one or more spots of dried reagent. In certain embodiments of the invention, the dried reagent may coat a surface of the reaction chamber. In certain embodiments of the invention, the dried reagent may coat some or all of the microposts. In certain embodiments of the invention, the microfluidic reaction chamber may comprise a liquid in the reaction chamber rehydrating the dried reagent.

The invention provides an instrument. The instrument may include a microfluidic reaction chamber. The instrument may include an actuator arranged relative to the active surface of the active surface device in a spatial relationship which permits the actuator to actuate the active surface.

The invention provides a microfluidic cartridge. The microfluidic cartridge may comprise a microfluidic reaction chamber that may be fitted into a recessed region within a microfluidic cartridge, thereby causing fluid coupling between an opening and the microfluidic cartridge.

The invention provides an instrument. The instrument may comprise a microfluidic cartridge and an actuator arranged relative to an active surface of an active surface device of the microfluidic cartridge in a spatial relationship which permits the actuator to actuate the active surface.

The invention provides a method of providing a microfluidic reaction chamber. The method may include providing an active surface. The method may include drying a reagent on the active surface. The method may include situating the active surface in a chamber housing, the chamber housing comprising an opening suitable for flowing a liquid into and/or out of the microfluidic reaction chamber.

The method of providing a microfluidic reaction chamber may comprise, in certain embodiments, layering a mask layer on the active surface prior to drying the reagent on the active surface.

In certain embodiments, the method of providing a microfluidic reaction chamber may include drying the reagent by depositing reagent droplets on the active surface and drying the droplets.

The method of providing a microfluidic reaction chamber may, in certain embodiments, include drying the reagent thereby producing multiple dried reagent spots on the active surface.

The method of providing a microfluidic reaction chamber may, in certain embodiments, include drying the reagent thereby producing a coating on the active surface.

The method of providing a microfluidic reaction chamber may, in certain embodiments, include situating the active surface in a chamber housing, the chamber housing comprising an opening suitable for flowing a liquid into and/or out of the microfluidic reaction chamber and drying a reagent on an inner surface of the chamber housing.

The method of providing a microfluidic reaction chamber may, in certain embodiments, include effectuating the drying of the reagent via an evaporative drying process.

The method of providing a microfluidic reaction chamber may, in certain embodiments, include effectuating the drying of the reagent via a freeze-drying process.

The invention provides a method of rehydrating a dried reagent for use in a microfluidic application. The method may include providing a microfluidic reaction chamber. The method may include flowing a rehydration solution into the reaction chamber. The method may include activating an active surface to cause the dried reagent to mix with the rehydration solution.

The invention provides a method of rehydrating a dried reagent for use in a microfluidic application. The method may include providing a microfluidic reaction chamber that is produced by any methods of the invention. The method may include flowing a rehydration solution into the reaction chamber. The method may include activating the active surface to cause the dried reagent to mix with the rehydration solution.

In certain embodiments of the method of providing a microfluidic reaction chamber or the method of rehydrating a dried reagent for use in a microfluidic application, the methods may further comprise performing a reaction, assay, or process in the active surface device.

In certain embodiments of the method of proving a microfluidic reaction chamber or the method of rehydrating a dried reagent for use in a microfluidic application, the methods may include the rehydration solution flowing into the microfluidic reaction chamber via an opening.

In certain embodiments of the method of providing a microfluidic reaction chamber or the method of rehydrating a dried reagent for use in a microfluidic application, the rehydration solution may comprise a buffer solution or deionized water.

In certain embodiments of the method of providing a microfluidic reaction chamber or the method of rehydrating a dried reagent for use in a microfluidic application, the active surface layer may comprise a micropost layer.

In certain embodiments of the method of providing a microfluidic reaction chamber or the method of rehydrating a dried reagent for use in a microfluidic application, the microposts may be substantially coated with a dried reagent.

In certain embodiments of the invention, the microfluidic reaction chamber may be separated by one or more dissolvable dried reagent barriers.

In certain embodiments of the invention, the dried inert reagent barrier may be dissolvable at a controlled rate, thereby acting as a valving mechanism within the active surface device.

In certain embodiments of the invention, the microfluidic reaction chamber may comprise two or more of the dried reagent barriers dissolvable at different rates.

In certain embodiments of the invention, the reagent barriers may comprise an inert reagent.

In certain embodiments of the invention, the dried reagent may comprise one or more reagents selected from the group consisting of cell lysis reagents, PCR reagents, proteins, antibodies, labels, stabilizers, and magnetic and non-magnetic beads.

Other compositions, methods, features, and advantages of the invention will be or will become apparent to one with skill in the art upon examination of the following figures and detailed description. It is intended that all such additional compositions, methods, features, and advantages be included within this description, be within the scope of the invention, and be protected by the accompanying claims.

### BRIEF DESCRIPTION OF THE DRAWINGS

The features and advantages of the present invention will be more clearly understood from the following description taken in conjunction with the accompanying drawings, which are not necessarily drawn to scale, and wherein:

FIG. 1A and FIG. 1B illustrate a perspective view and an exploded view, respectively, of an example of the presently disclosed active surface device in accordance with a simplest embodiment;

FIG. 2A and FIG. 2B illustrate side views of an example of microposts in the presently disclosed active surface devices for providing dried reagents in microfluidic applications;

FIG. 3A and FIG. 3B illustrate side views of a micropost and show examples of the actuation motion thereof;

FIG. 4A and FIG. 4B illustrate a perspective view and a cross-sectional view, respectively, of an example of an active surface device including a dried reagent “spot,” which is one example of the presently disclosed active surface devices for providing dried reagents in microfluidic applications;

FIG. 5A and FIG. 5B illustrate an example of the active surface device including a dried reagent “spot” shown in FIG. 4A and FIG. 4B in relation to a fluidics cartridge;

FIG. 6A and FIG. 6B illustrate a perspective view and a cross-sectional view, respectively, of an example of an active surface device including a dried reagent coating, which is another example of the presently disclosed active surface devices for providing dried reagents in microfluidic applications;

FIG. 7A and FIG. 7B illustrate an example of the active surface device including a dried reagent coating shown in FIG. 6A and FIG. 6B in relation to a fluidics cartridge;

FIG. 8A through FIG. 8F illustrate side views of examples of different configurations of dried reagents and microposts in the presently disclosed active surface devices for providing dried reagents in microfluidic applications;

FIG. 9 illustrates a flow diagram of an example of a method of forming a dried reagent “spot” in the presently disclosed active surface devices for providing dried reagents in microfluidic applications;

FIG. 10A and FIG. 10B illustrate plan views of an example of a sheet of active surface devices and a single active surface device, respectively, that can be processed;

FIG. 11A shows images of reagent before and after rehydrating using active mixing in the presently disclosed active surface devices;

FIG. 11B shows a plot indicating the mixing efficiency of the presently disclosed active surface devices;

FIG. 12 illustrates a flow diagram of an example of a method of forming a dried reagent coating in the presently disclosed active surface devices for providing dried reagents in microfluidic applications;

FIG. 13 illustrates a flow diagram of an example of a method of using the presently disclosed active surface devices for providing dried reagents in microfluidic applications;

FIG. 14 illustrates a plan view of an example of an active surface device that may include multiple reaction (or assay) chambers and wherein any chamber may include one or multiple dried reagent “spots;”

FIG. 15 illustrates a cross-sectional view of an example of a process of depositing multiple dried reagent “spots;”

FIG. 16A and FIG. 16B illustrate plan views of examples of multiple dried reagent “spots” deposited in patterns that correspond to the mixing action of the microposts for maximizing the interaction of the reagents;

FIG. 17A, FIG. 17B, FIG. 17C, and FIG. 17D illustrate plan views of an example of dried inert reagent barriers in a reaction (or assay) chamber and a valving process for staging flow;

FIG. 18A and FIG. 18B illustrate plan views of an example of dried inert reagent barriers in a reaction (or assay) chamber for directing flow; and

FIG. 19A and FIG. 19B illustrate a cross-sectional view and a perspective view, respectively, of an example of the presently disclosed active surface device including dried reagent and including vapor barrier mechanisms.

### DETAILED DESCRIPTION OF EXEMPLARY EMBODIMENTS

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

### General Definitions

As used herein “active surface” means any surface or area that can be used for processing samples including, but not limited to, biological materials, fluids, environmental samples (e.g., water samples, air samples, soil samples, solid and liquid wastes, and animal and vegetable tissues), and industrial samples (e.g., food, reagents, and the like). The active surface can be inside a reaction or assay chamber. For example, the active surface can be any surface that has properties designed to manipulate the fluid inside the chamber. Manipulation can include, for example, generating fluid flow, altering the flow profile of an externally driven fluid, fractionating the sample into constituent parts, establishing or eliminating concentration gradients within the chamber, and the like. Surface properties that might have this effect can include, for example, post technology—whether static or actuated (i.e., activated). The surface properties may also include microscale texture or topography in the surface, physical perturbation of the surface by vibration or deformation; electrical, electronic, electromagnetic, and/or magnetic system on or in the surface; optically active (e.g., lenses) surfaces, such as embedded LEDs or materials that interact with external light sources; and the like.

As used herein, the terms “surface-attached post” or “surface-attached micropost” or “surface-attached structure” or “micropost” are used interchangeably. Generally, a surface-attached structure has two opposing ends: a fixed end and a free end. The fixed end may be attached to a substrate by any suitable means, depending on the fabrication technique and materials employed. The fixed end may be “attached” by being integrally formed with or adjoined to the substrate, such as by a microfabrication process. Alternatively, the fixed end may be “attached” via a bonding, adhesion, fusion, or welding process. The surface-attached structure has a length defined from the fixed end to the free end, and a cross-section lying in a plane orthogonal to the length. For example, using the Cartesian coordinate system as a frame of reference, and associating the length of the surface-attached structure with the z-axis (which may be a curved axis), the cross-section of the surface-attached structure lies in the x-y plane.

Generally, the cross-section of the surface-attached structure may have any shape, such as rounded (e.g., circular, elliptical, etc.), polygonal (or prismatic, rectilinear, etc.), polygonal with rounded features (e.g., rectilinear with rounded corners), or irregular. The size of the cross-section of the surface-attached structure in the x-y plane may be defined by the “characteristic dimension” of the cross-section, which is shape-dependent. As examples, the characteristic dimension may be diameter in the case of a circular cross-section, major axis in the case of an elliptical cross-section, or maximum length or width in the case of a polygonal cross-section. The characteristic dimension of an irregularly shaped cross-section may be taken to be the dimension characteristic of a regularly shaped cross-section that the irregularly shaped cross-section most closely approximates (e.g., diameter of a circle, major axis of an ellipse, length or width of a polygon, etc.).

A surface-attached structure as described herein is non-movable (static, rigid, etc.) or movable (flexible, deflectable, bendable, etc.) relative to its fixed end or point of attachment to the substrate. To facilitate the movability of movable surface-attached structures, the surface-attached structure may include a flexible body composed of an elastomeric (flexible) material, and may have an elongated geometry in the sense that the dominant dimension of the surface-attached structure is its length—that is, the length is substantially greater than the characteristic dimension. Examples of the composition of the flexible body include, but are not limited to, elastomeric materials such as hydrogel and other active surface materials (for example, polydimethylsiloxane (PDMS)).

The movable surface-attached structure is configured such that the movement of the surface-attached structure relative to its fixed end may be actuated or induced in a non-contacting manner, specifically by an applied magnetic or electric field of a desired strength, field line orientation, and frequency (which may be zero in the case of a magneto static or electrostatic field). To render the surface-attached structure movable by an applied magnetic or electric field, the surface-attached structure may include an appropriate metallic component disposed on or in the flexible body of the surface-attached structure. To render the surface-attached structure responsive to a magnetic field, the metallic component may be a ferromagnetic material such as, for example, iron, nickel, cobalt, or magnetic alloys thereof, one non-limiting example being “alnico” (an iron alloy containing aluminum, nickel, and cobalt). To render the surface-attached structure responsive to an electric field, the metallic component may be a metal exhibiting good electrical conductivity such as, for example, copper, aluminum, gold, and silver, and well as various other metals and metal alloys. Depending on the fabrication technique utilized, the metallic component may be formed as a layer (or coating, film, etc.) on the outside surface of the flexible body at a selected region of the flexible body along its length. The layer may be a continuous layer or a densely grouped arrangement of particles. Alternatively, the metallic component may be formed as an arrangement of particles embedded in the flexible body at a selected region thereof.

As used herein, the term “actuation force” refers to the force applied to the microposts. For example, the actuation force may include a magnetic, thermal, sonic, or electric force. Notably, the actuation force may be applied as a function of frequency or amplitude, or as an impulse force (i.e., a step function). Similarly, other actuation forces may be used without departing from the scope of the present subject matter, such as fluid flow across the micropost array (e.g., flexible microposts that are used as flow sensors via monitoring their tilt angle with an optical system).

Accordingly, the application of an actuation force actuates the movable surface-attached microposts into movement. For example, the actuation occurs by contacting the cell processing chamber with the control instrument comprising elements that provide an actuation force, such as a magnetic or electric field. Accordingly, the control instrument includes, for example, any mechanisms for actuating the microposts (e.g., magnetic system), any mechanisms for counting the cells (e.g., imaging system), the pneumatics for pumping the fluids (e.g., pumps, fluid ports, valves), and a controller (e.g., microprocessor).

As used herein, a “flow cell” is any chamber comprising a solid surface across which one or more liquids can be flowed, wherein the chamber has at least one inlet and at least one outlet.

The term “micropost array” is herein used to describe an array of small posts, extending outwards from a substrate, that typically range from 1 to 100 micrometers in height. In one embodiment, microposts of a micropost array may be vertically aligned. Notably, each micropost includes a proximal end that is attached to the substrate base and a distal end or tip that is opposite the proximal end. Microposts may be arranged in arrays such as, for example, the microposts described in U.S. Pat. No. 9,238,869, entitled “Methods and systems for using actuated surface-attached posts for assessing biofluid rheology,” issued on Jan. 19, 2016; the entire disclosure of which is incorporated herein by reference. U.S. Pat. No. 9,238,869 describes methods, systems, and computer readable media for using actuated surface-attached posts for assessing biofluid rheology. One method described in U.S. Pat. No. 9,238,869 is directed to testing properties of a biofluid specimen that includes placing the specimen onto a micropost array having a plurality of microposts extending outwards from a substrate, wherein each micropost includes a proximal end attached to the substrate and a distal end opposite the proximal end, and generating an actuation force in proximity to the micropost array to actuate the microposts, thereby compelling at least some of the microposts to exhibit motion. This method further includes measuring the motion of at least one of the microposts in response to the actuation force and determining a property of the specimen based on the measured motion of the at least one micropost.

U.S. Pat. No. 9,238,869 also states that the microposts and micropost substrate of the micropost array can be formed of polydimethylsiloxane (PDMS). Further, microposts may include a flexible body and a metallic component disposed on or in the body, wherein application of a magnetic or electric field actuates the microposts into movement relative to the surface to which they are attached (e.g., wherein the actuation force generated by the actuation mechanism is a magnetic and/or electrical actuation force).

“Magnetically responsive” means responsive to a magnetic field. “Magnetically responsive microposts” include or are composed of magnetically responsive materials. Examples of magnetically responsive materials include, but are not limited to, paramagnetic materials, ferromagnetic materials, ferrimagnetic materials, and metamagnetic materials. Examples of suitable paramagnetic materials include iron, nickel, and cobalt, as well as metal oxides, such as, but not limited to, ferroferric oxide (Fe₃O₄), barium hexaferrite (BaFe₁₂O₁₉), cobalt(II) oxide (CoO), nickel(II) oxide (NiO), manganese(III) oxide (Mn₂O₃), chromium(III) oxide (Cr₂O₃), and cobalt manganese phosphide (CoMnP).

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### Active Surface Devices for and Methods of Providing Dried Reagents in Microfluidic Applications

In some embodiments, the presently disclosed subject matter provides active surface devices for and methods of providing dried reagents in microfluidic applications. For example, the presently disclosed active surface devices is a delivery mechanism for providing dried reagents in fluidic and/or microfluidic devices, cartridges, and/or systems. Additionally, the presently disclosed active surface devices provide mechanisms for rapidly rehydrating the dried reagents and for ensuring homogeneous mixing of the rehydrated reagents.

In some embodiments, the presently disclosed active surface devices include a dried reagent “spot” in relation to an active surface in the reaction (or assay) chamber thereof.

In some embodiments, the presently disclosed active surface devices include multiple dried reagent “spots” in relation to an active surface in the reaction (or assay) chamber thereof and wherein the dried reagent “spots” may be formed of the same or different types of reagent material.

In some embodiments, the presently disclosed active surface devices include a dried reagent coating on the surfaces of the reaction (or assay) chamber and wherein at least one surface of the chamber is an active surface.

In some embodiments, the presently disclosed active surface devices include multiple reaction (or assay) chambers wherein each chamber may include dried reagent and an active surface.

In some embodiments, the presently disclosed active surface devices include dried reagent in relation to a “micropost” active surface that includes a micropost array.

In some embodiments, the presently disclosed active surface devices include dried reagent in relation to a “micropost” active surface and wherein the “micropost” active surface provides active mixing action for rapidly rehydrating the dried reagents and for ensuring homogeneous mixing of the rehydrated reagents.

In some embodiments, the presently disclosed active surface devices include multiple dried reagent “spots” patterned in the reaction (or assay) chamber in a manner that corresponds to the mixing action of the “micropost” active surface for maximizing the interaction of the reagents.

In some embodiments, the presently disclosed active surface devices include dried inert reagent barriers that are dissolvable and can be used, for example, for directing or metering flow and/or valving functions in the reaction (or assay) chamber.

In some embodiments, the presently disclosed active surface devices include a mask layer sheet that may be an adhesive (usually double-sided) that is cut to provide a void where a reaction will take place. The mask layer sheet may be adhered to a blank substrate which may or may not have microposts thereon. The mask layer sheet remains during use as it provides a boundary that keeps fluids contained in the active surface device during its placement in recessed regions in a microfluidic cartridge. In various embodiments, mask layer sheets can be made, for example, from silicone-based adhesives or acrylic-based adhesives. The mask layer sheet can also be a laminate made by laminating two or more materials together. By way of example, but not limitation, the laminate may have an acrylic adhesive on one surface layer, a silicone adhesive on an opposite surface layer, and a silicone spacer that separates the two surfaces thereby forming a gap between the two surfaces. The resulting laminate can be applied and sealed to the blank substrate, for example, using pressure, e.g., a pressure-sensitive adhesive.

Additionally, a method of forming a dried reagent “spot” in the presently disclosed active surface devices is provided.

Additionally, a method of forming a dried reagent coating in the presently disclosed active surface devices is provided.

Additionally, a method of using the presently disclosed active surface devices for providing dried reagents in microfluidic applications is provided.

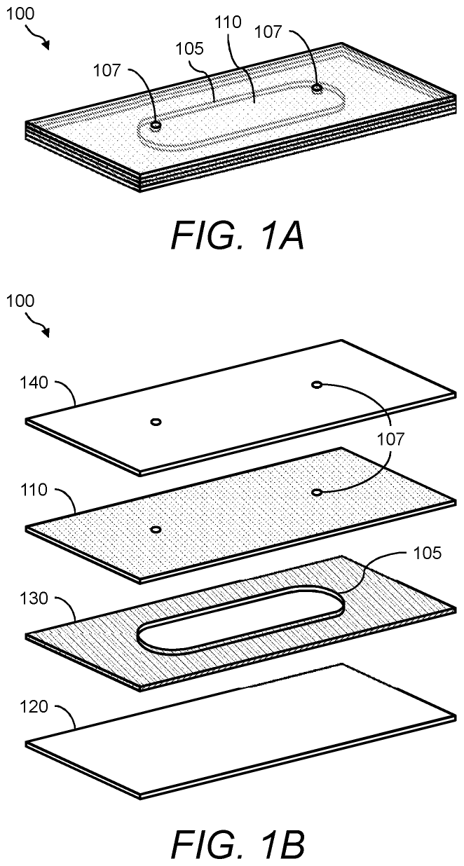

FIG. 1A shows a perspective view of an example of the presently disclosed active surface device 100 in accordance with a simplest embodiment. FIG. 1B shows an exploded view of the active surface device 100 shown in FIG. 1A. In this example, active surface device 100 provides a structure that includes a reaction (or assay) chamber 105 that includes at least one active surface layer 110. Further, active surface device 100 includes loading ports 107 in relation to reaction chamber 105. Loading ports 107 can be used for flowing liquid in or out of reaction chamber 105 and/or for venting reaction chamber 105. In this example, active surface device 100 provides a simple flow cell device.

Referring now to FIG. 1B, active surface device 100 includes a bottom substrate 120, then a mask layer 130, then active surface layer 110, and then an active surface substrate 140. Active surface substrate 140 is the top substrate of active surface device 100. Mask layer 130 defines the area, height, and volume of reaction chamber 105. In reaction chamber 105, bottom substrate 120 provides the facing surface to active surface layer 110. In other examples, instead of bottom substrate 120 facing the active surface layer 110, active surface device 100 can include two active surface layers 110 that face each other.

Further, active surface device 100 shown in FIG. 1A and FIG. 1B includes a bottom substrate and a top substrate. However, the terms “top,” “bottom,” “upper,” “lower,” “over,” “under,” “in,” and “on” are used throughout the description with reference to the relative positions of components of active surface device 100 and any devices based thereon. It will be appreciated that active surface device 100 is functional regardless of its orientation in space.

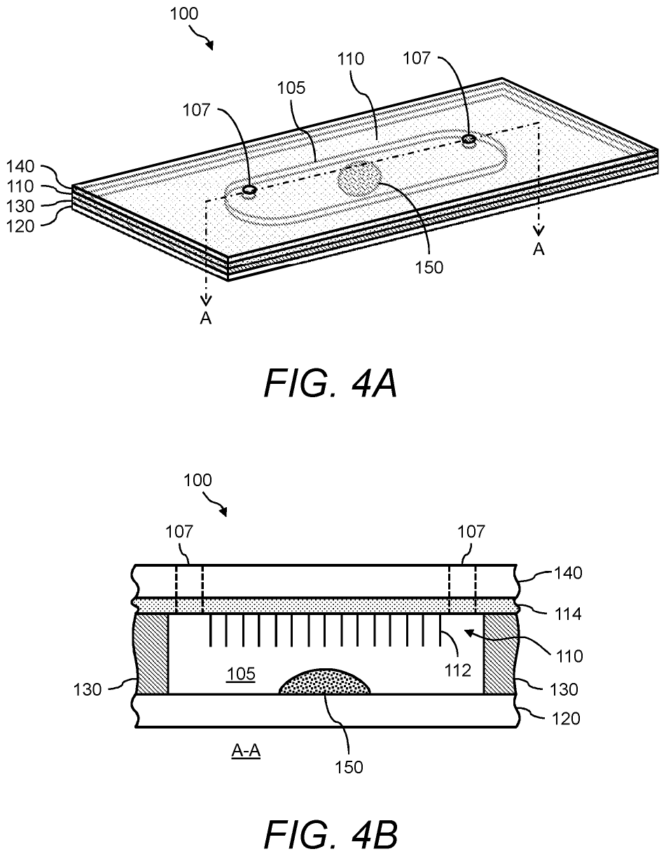

In the presently disclosed active surface device 100, dried reagent in various forms may be provided in reaction chamber 105. In this way, active surface device 100 acts as a delivery mechanism for providing dried reagents in fluidic and/or microfluidic devices, cartridges, and/or systems. More details of active surface device 100 with dried reagents therein are shown and described hereinbelow with reference to FIG. 4A through FIG. 19B.

### Example

### Micropost-Based Active Surface Device

For illustration purposes only, the active surface device 100 described hereinbelow is based on micropost technology. For example, in the example described hereinbelow, the active surface layer 110 is a “micropost” active surface layer 110 that includes a micropost array. However, active surface device 100 is not limited to a “micropost” active surface layer. This is exemplary only. Other types of active surfaces are possible.

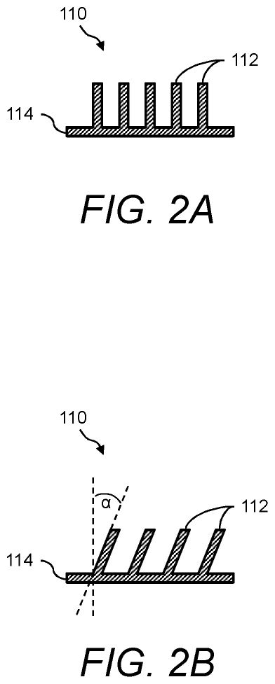

Referring now to FIG. 2A and FIG. 2B is side views of a portion of “micropost” active surface layer 110, wherein microposts 112 can be arranged in a micropost field or array. The term “micropost field” or “micropost array” is herein used to describe a field or an array of small posts, extending outwards from a substrate, that typically range from 1 to 100 micrometers in height. In one embodiment, microposts of a micropost field or array may be vertically aligned. Notably, each micropost includes a proximal end that is attached to the substrate base and a distal end or tip that is opposite the proximal end. Accordingly, an arrangement of microposts 112 are provided on a substrate 114. The arrangement of microposts 112 on substrate 114 is an example of “micropost” active surface layer 110, hereafter called micropost active surface layer 110.

Microposts 112 and substrate 114 can be formed, for example, of polydimethylsiloxane (PDMS). The length, diameter, geometry, orientation, and pitch of microposts 112 in the field or array can vary. For example, the length of microposts 112 can vary from about 1 μm to about 100 μm. The diameter of microposts 112 can vary from about 0.1 μm to about 10 μm. Further, the cross-sectional shape of microposts 112 can vary. For example, the cross-sectional shape of microposts 112 can be circular, ovular, square, rectangular, triangular, and so on. The orientation of microposts 112 can vary. For example, FIG. 2A shows microposts 112 oriented substantially normal to the plane of substrate 114, while FIG. 2B shows microposts 112 oriented at an angle α with respect to normal of the plane of substrate 114. In a neutral position with no actuation force applied, the angle α may be, for example, from about 0 degrees to about 45 degrees. Additionally, the pitch of microposts 112 within a micropost field or array can vary, for example, from about 0 μm to about 50 μm. Further, the relative positions of microposts 112 within the micropost field or array can vary.

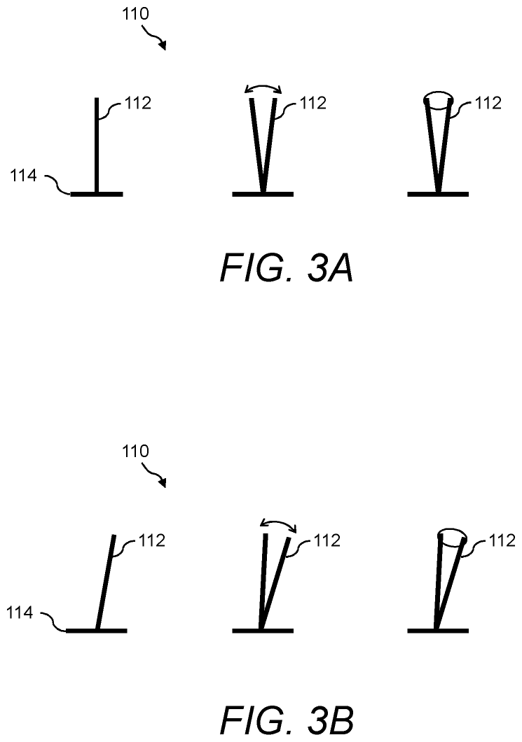

FIG. 3A and FIG. 3B show side views of a micropost 112 and show examples of the actuation motion thereof. FIG. 3A shows an example of a micropost 112 oriented substantially normal to the plane of substrate 114. FIG. 3A shows that the distal end of the micropost 112 can move (1) with side-to-side 2D motion only with respect to the fixed proximal end or (2) with circular motion with respect to the fixed proximal end, which is a cone-shaped motion. By contrast, FIG. 3B shows an example of a micropost 112 oriented at an angle with respect to the plane of substrate 114. FIG. 3B shows that the distal end of the micropost 112 can move (1) with tilted side-to-side 2D motion only with respect to the fixed proximal end or (2) with tilted circular motion with respect to the fixed proximal end, which is a tilted cone-shaped motion. In any microposts processing platform 100, by actuating microposts 112 and causing motion thereof, any fluid in reaction (or assay) chamber 105 is in effect stirred or caused to flow or circulate. Further, the cone-shaped motion of micropost 112 shown in FIG. 3A, as well as the tilted cone-shaped motion of micropost 112 shown in FIG. 3B, can be achieved using a rotating magnetic field. A rotating magnetic field is one example of the “actuation force” of a microposts actuation mechanism.

Referring still to FIG. 1A through FIG. 3B, microposts 112 are based on, for example, the microposts described in the U.S. Pat. No. 9,238,869, entitled “Methods and systems for using actuated surface-attached posts for assessing biofluid rheology;” the entire disclosure of which is incorporated herein by reference. In one example, according to the '869 patent, microposts 112 and substrate 114 can be formed of PDMS.

FIG. 4A illustrates a perspective view of an example of active surface device 100 including a dried reagent “spot,” which is one example of the presently disclosed active surface devices for providing dried reagents in microfluidic applications. FIG. 4B illustrates a cross-sectional view of active surface device 100 taken along line A-A of FIG. 4A. In this example, a dried reagent spot 150 is provided atop bottom substrate 120 and in reaction chamber 105. That is, dried reagent spot 150 is provided on the surface of reaction chamber 105 that is opposite micropost active surface layer 110. In one example, reaction chamber 105 is a 20 μL-reaction chamber.

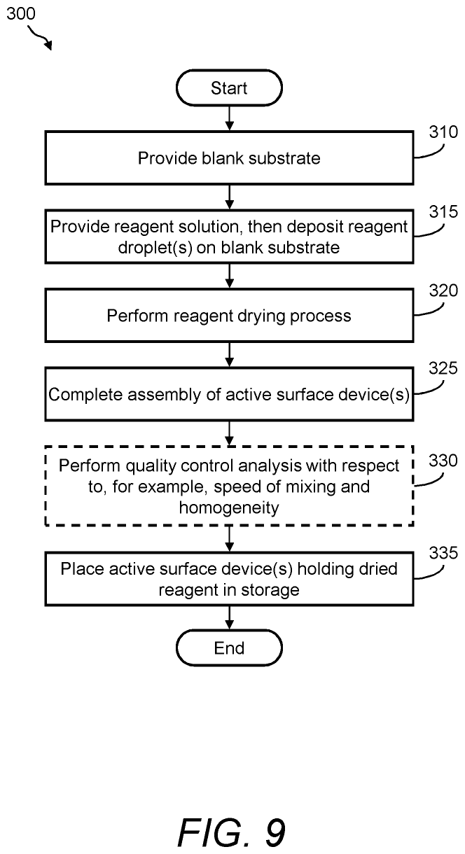

In one example, dried reagent spot 150 can be formed by depositing a quantity of reagent solution on bottom substrate 120 and then undergoing a drying process, such as, but not limited to, a freeze-drying process (i.e., lyophilization) or an evaporative drying (i.e., dehydration) and leaving behind a bolus or cake-like structure of dried reagent spot 150. As is well known, lyophilization (or cryodesiccation) is a low temperature dehydration process that involves freezing the product, lowering pressure, then removing the ice by sublimation. By contrast, evaporative drying (i.e., dehydration) uses heat to evaporate water. More details of an example of a process of forming dried reagent spot 150 in reaction chamber 105 of active surface device 100 are shown and described hereinbelow with reference to FIG. 9.

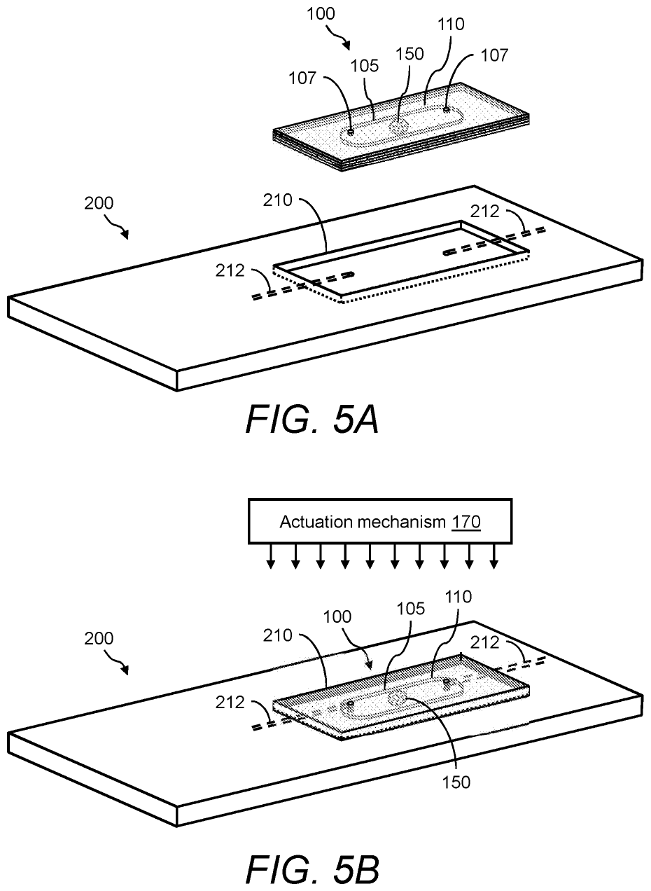

FIG. 5A and FIG. 5B illustrate an example of active surface device 100 including a dried reagent “spot” (e.g., dried reagent spot 150) shown in FIG. 4A and FIG. 4B in relation to a fluidics cartridge 200. For example, active surface device 100 is designed to drop-into a corresponding fluidics cartridge, such as fluidics cartridge 200. In this example, fluidics cartridge 200 includes a recessed region 210 for receiving active surface device 100. Namely, active surface device 100 is sized to be fitted into recessed region 210 of fluidics cartridge 200. Further, the positions of loading ports 107 of active surface device 100 are set to correspond to fluid lines 212 in fluidics cartridge 200. In this way, active surface device 100 can be fluidly coupled to fluidics cartridge 200. An adhesive (e.g., a peel off adhesive layer, not shown) may be provided on the underside of active surface device 100 for easy installation and bonding to the surfaces of fluidics cartridge 200.

Referring still to FIG. 5B, an actuation mechanism 170 is arranged in close proximity to reaction chamber 105 of active surface device 100. Actuation mechanism 170 can be any mechanism for actuating microposts 112 of micropost active surface layer 110 in active surface device 100. As used herein, the term “actuation force” refers to the force applied to microposts 112. Actuation mechanism 170 is used to generate an actuation force in proximity to micropost active surface layer 110 that compels at least some of microposts 112 to exhibit motion. By actuating microposts 112 and causing motion thereof, any liquid (not shown) in reaction chamber 105 is in effect stirred or caused to flow or circulate within the 3D space of reaction chamber 105.

The actuation force may be, for example, magnetic, thermal, sonic, and/or electric force. Further, the actuation force may be applied as a function of frequency or amplitude, or as an impulse force (i.e., a step function). Similarly, other actuation forces may be used without departing from the scope of the present subject matter, such as fluid flow across micropost active surface layer 110. In one example, microposts 112 are magnetically responsive microposts and actuation mechanism 170 may be one of the magnetic-based actuation mechanisms described with reference to U.S. Patent App. No. 62/654,048, entitled “Magnetic-Based Actuation Mechanisms for and Methods of Actuating Magnetically Responsive Microposts in a Reaction Chamber,” filed on Apr. 16, 2018.

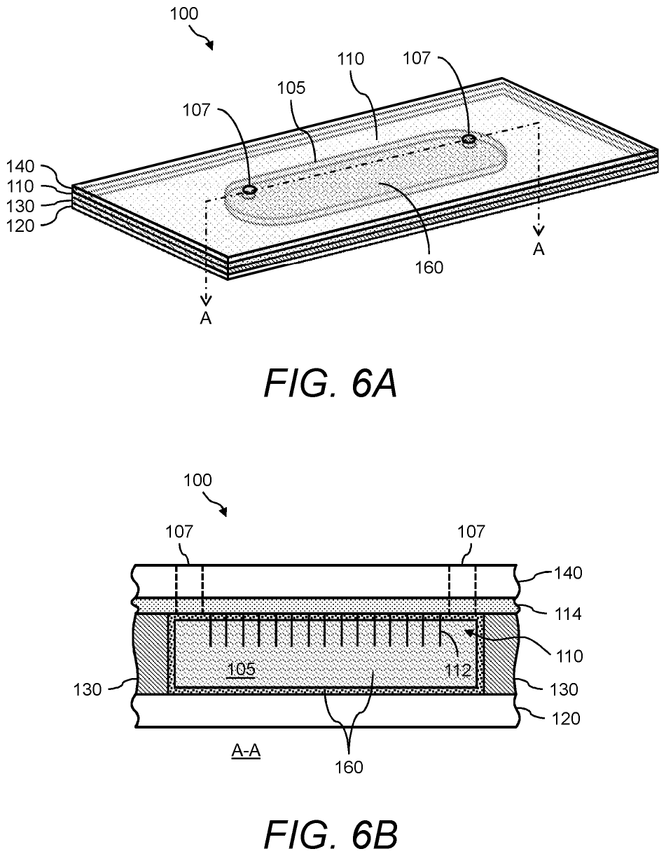

FIG. 6A illustrates a perspective view of an example of active surface device 100 including a dried reagent coating, which is another example of the presently disclosed active surface devices for providing dried reagents in microfluidic applications. FIG. 6B illustrates a cross-sectional view of active surface device 100 taken along line A-A of FIG. 6A. In this example, a dried reagent coating 160 is provided on substantially all surfaces of reaction chamber 105. That is, dried reagent coating 160 is provided on the surface of bottom substrate 120, on the surface of micropost active surface layer 110 (including microposts 112), and on the sidewalls of reaction chamber 105. In one example, reaction chamber 105 is a 20 μL-reaction chamber.

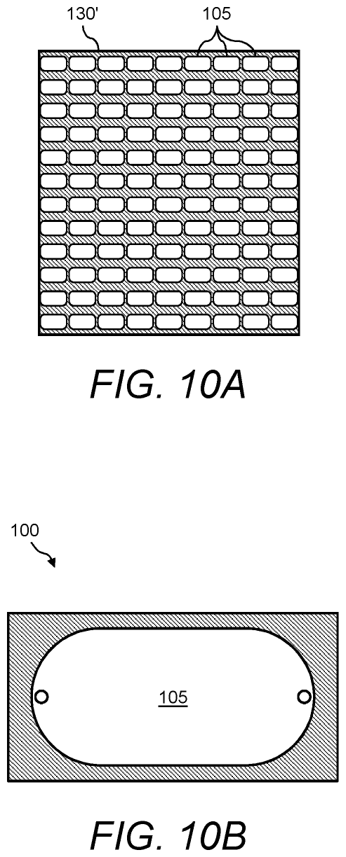

In one example, dried reagent coating 160 can be formed by flooding reaction chamber 105 with a quantity of liquid reagent and then undergoing a drying process, such as, but not limited to, a freeze-drying process (i.e., lyophilization) or an evaporative drying (i.e., dehydration), to remove moisture/water from reaction chamber 105 and leaving behind dried reagent coating 160. Dried reagent coating 160 may be, for example, a coating of reagent powder. More details of an example of a process of forming dried reagent coating 160 in reaction chamber 105 of active surface device 100 are shown and described hereinbelow with reference to FIG. 10.

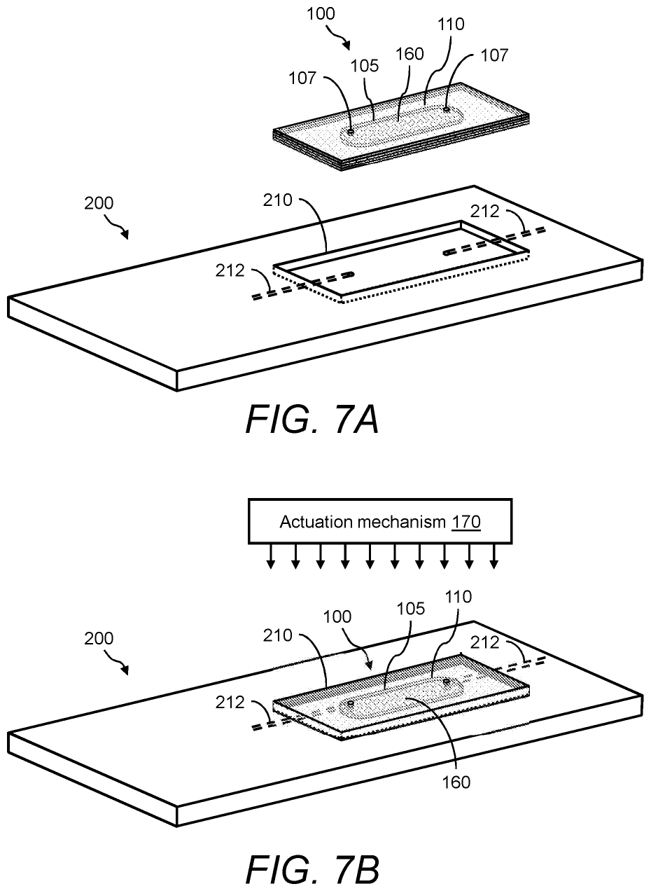

FIG. 7A and FIG. 7B illustrate an example of active surface device 100 including a dried reagent coating (e.g., dried reagent coating 160) shown in FIG. 6A and FIG. 6B in relation to fluidics cartridge 200. Again, active surface device 100 is designed to drop-into a corresponding fluidics cartridge, such as fluidics cartridge 200. Again, actuation mechanism 170 is arranged in close proximity to reaction chamber 105 of active surface device 100

In active surface device 100 including either dried reagent spot 150 (see FIG. 4A through FIG. 5B) or dried reagent coating 160 (see FIG. 6A through FIG. 7B) in relation to micropost active surface layer 110, micropost active surface layer 110 provides active mixing action for (1) rapidly rehydrating the dried reagents and (2) ensuring homogeneous mixing of the rehydrated reagents.

Examples of reagents for forming dried reagent spot 150 (see FIG. 4A through FIG. 5B) and/or dried reagent coating 160 (see FIG. 6A through FIG. 7B) may include, but it not limited to, the following:
(1) Lysis reagent—For example, a lysis reagent to burst HIV virus to get out the nucleic acid;
(2) Reverse Transcriptase—reagents used to turn RNA into cDNA (cDNA needed for most amplification methods;
(3) Reagents for PCR master mix, nucleotides, primers, probes, baits;
(4) Reagents including proteins, antibodies, labels (fluorescent dyes, contrast agents), and the like;
(5) Reagents including stabilizers (see Table 1 below); and
(6) Beads (magnetic or non-magnetic)—beads can be coated with most of the “reagents” described above. Beads could also be used to trigger cell differentiation (e.g., CAR-T cells) or to damage cells when used in combination with active microposts.

Further, active surface device 100 including either dried reagent spot 150 (see FIG. 4A through FIG. 5B) or dried reagent coating 160 (see FIG. 6A through FIG. 7B) is designed for maximum shelf stability. Accordingly, the formulation for forming dried reagent spot 150 and dried reagent coating 160 may include stabilizer agents. For example, Table 1 below shows an example of two recipes that include a protein stabilizer and an example of two recipes that include a PCR mastermix stabilizer (PCR means Polymerase Chain Reaction).

TABLE 1
Reagent formulations including stabilizers

| | |
|---|---|
| Reagent/Protein Stabilizer Recipe 1 | 5 mM Histidine, |
| | 20 mM Sucrose, |
| | 40 mM Mannitol, |
| | Polysorbate 20 (Tween) [0.05% |
| | v/v], |
| | Bromophenol Blue (0.01% w/v) |
| Reagent/Protein Stabilizer Recipe 2 | 5 mM Histidine, |
| | 20 mM Trehalose, |
| | 40 mM Mannitol, |
| | Polysorbate 20 (Tween) [0.05% |
| | v/v], |
| | Bromophenol Blue (0.01% w/v) |
| Reagent/PCR Mastermix Stabilizer | Trehalose (5% w/v), |
| Recipe 1 | Bromophenol Blue (0.01% w/v) |
| Reagent/PCR Mastermix Stabilizer | Sorbitol (5% w/v), |
| Recipe 2 | Bromophenol Blue (0.01% w/v) |

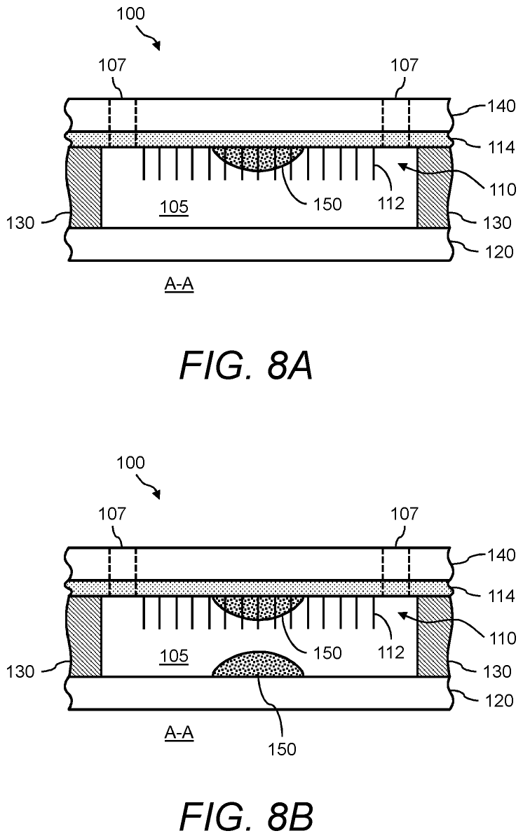

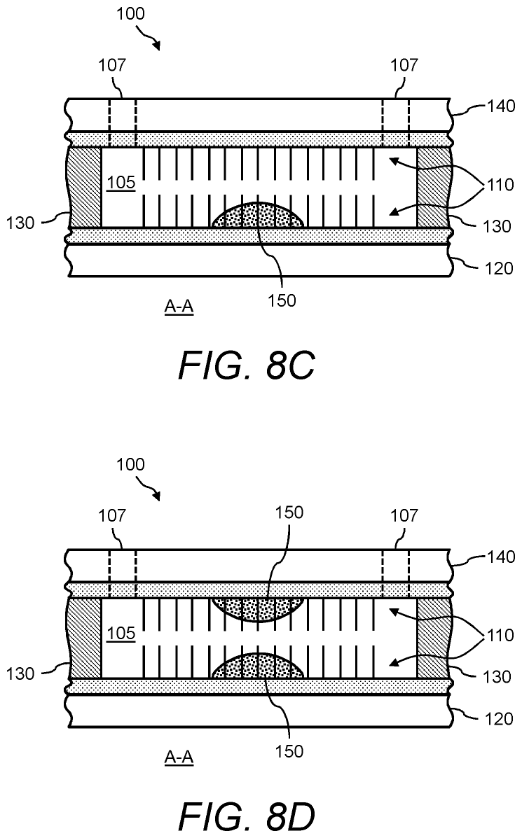

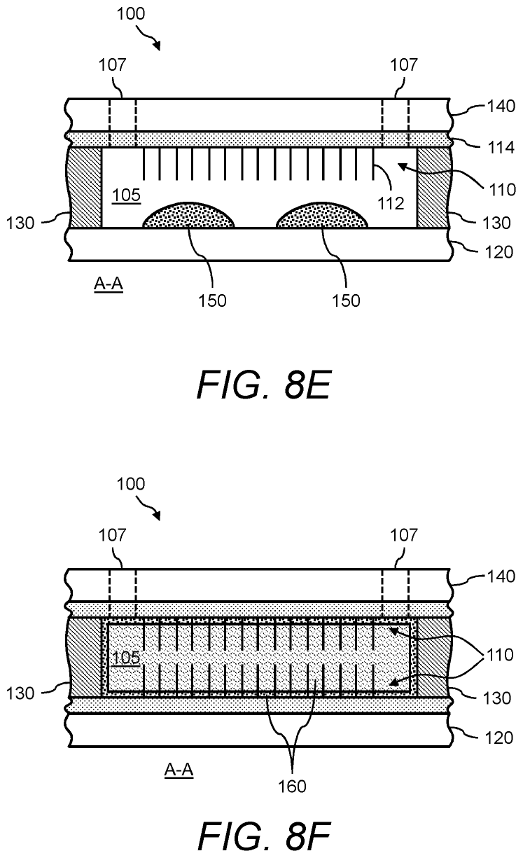

Active surface device 100 is not limited to the configurations of micropost active surface layers 110, dried reagent spots 150, and/or dried reagent coatings 160 shown in FIG. 4A through FIG. 7B. These configurations are exemplary only. Other configurations are possible, such as, but not limited to, those shown hereinbelow with reference to FIG. 8A through FIG. 8F.

For example, FIG. 8A shows an example of active surface device 100 in which a dried reagent spot 150 is provided on the same surface as microposts 112. That is, dried reagent spot 150 is provided on micropost active surface layer 110 instead of on bottom substrate 120.

FIG. 8B shows an example of active surface device 100 in which a dried reagent spot 150 is provided on both bottom substrate 120 and micropost active surface layer 110.

FIG. 8C shows an example of active surface device 100 in which a dried reagent spot 150 is provided on bottom substrate 120 and a micropost active surface layer 110 is provided on both the top and bottom of reaction chamber 105.

FIG. 8D shows an example of active surface device 100 in which a micropost active surface layer 110 is provided on both the top and bottom of reaction chamber 105 and in which a dried reagent spot 150 is provided on both the top and bottom micropost active surface layers 110.

FIG. 8E shows an example of active surface device 100 that includes more than one dried reagent spots 150. In this example, two dried reagent spots 150 are provided, for example, on bottom substrate 120. However, this is exemplary only. More than one dried reagent spots 150 can be deposited on any surfaces of reaction chamber 105.

FIG. 8F shows an example of active surface device 100 in which a micropost active surface layer 110 is provided on both the top and bottom of reaction chamber 105 and that includes dried reagent coating 160 on substantially all surfaces thereof.

FIG. 9 illustrates a flow diagram of an example of a method 300 of forming a dried reagent “spot” (e.g., dried reagent spot 150) in the presently disclosed active surface devices for providing dried reagents in microfluidic applications. In one example, method 300 may be performed in a bulk manufacturing environment, which is represented by a mask layer sheet 130′ shown in FIG. 10A for forming active surface devices 100 in bulk. In another example, method 300 may be performed at a single-device level. In this example, method 300 may be used to form individual active surface devices 100, such as the single active surface device 100 shown in FIG. 10B. The single active surface device 100 shown in FIG. 10B is representative of mask layer sheet 130′ shown in FIG. 10A after dicing. Method 300 may include, but is not limited to, the following steps.

At a step 310, a blank substrate is provided. In a bulk manufacturing environment, bottom substrate 120 is provided in sheet form suitable for forming active surface devices 100 in bulk. Additionally, in a single-device manufacturing environment, bottom substrate 120 is provided for a single active surface device 100. In any case, bottom substrate 120 may be formed, for example, of glass, plastic, silicon, polymer, and the like. Optionally, the processing surface of bottom substrate 120 can be treated to keep the liquid droplet from spreading (in step 315). For example, the surface of bottom substrate 120 can be functionalized to make it hydrophobic.

At a step 315, the reagent solution is provided, then droplet(s) of reagent solution is deposited on the blank substrate. For example, reagent solution may be provided according to the formulations shown hereinabove with reference to Table 1, such as “Reagent/Protein Stabilizer Recipe 1,” “Reagent/Protein Stabilizer Recipe 2,” “Reagent/PCR Mastermix Stabilizer Recipe 1,” and “Reagent/PCR Mastermix Stabilizer Recipe 2.”

In one example, in a bulk manufacturing environment using an evaporative drying process, bottom substrate 120 may be heated or held at room temperature (e.g., by sitting bottom substrate 120 on a heated block) while the reagent solution is “spotted” out using, for example, a non-contact spotter that runs over the sheet and deposits the spots easily.

In another example, in a bulk manufacturing environment using a freeze-drying process (i.e., lyophilization), bottom substrate 120 may be chilled (e.g., at between about −20° C. to about −80° C., typically at about −40° C.) (e.g., by sitting bottom substrate 120 on a cold block) while the reagent solution is “spotted” out using the non-contact spotter. Chilling bottom substrate 120 causes the droplet(s) of reagent solution to flash-freeze upon contact with bottom substrate 120.

In yet another example, in a single-device manufacturing environment using an evaporative drying process, bottom substrate 120 may be heated or held at room temperature (e.g., by sitting bottom substrate 120 on a heated block) while a droplet of reagent solution is “spotted” out using, for example, a pipette.

In still another example, in a single-device manufacturing environment using a freeze-drying process (i.e., lyophilization), bottom substrate 120 may be chilled (e.g., at between about −20° C. to about −80° C., typically at about −40° C.) (e.g., by sitting bottom substrate 120 on a cold block) while a droplet of reagent solution is “spotted” out using, for example, a pipette.

Continuing step 315, in any of the above-mentioned processes the droplet(s) of reagent solution are deposited with precise positioning and in precise amounts (i.e., volumes) for the following reasons: (1) to ensure that each of the resulting dried reagent spots 150 is aligned properly with its corresponding reaction chamber 105 of its corresponding active surface device 100; (2) to ensure that the footprint of each of the resulting dried reagent spots 150 does not exceed the footprint of its corresponding reaction chamber 105 of its corresponding active surface device 100; and (3) to ensure that the height of each of the resulting dried reagent spots 150 does not interfere with microposts 112 of micropost active surface layer 110. In other words, to ensure that each of the resulting dried reagent spots 150 does not crush microposts 112 when the active surface device 100 is assembled.

At a step 320, a reagent drying process is performed. In one example, in a bulk manufacturing environment using an evaporative drying process, bottom substrate 120 with the “spots” of reagent solution may sit out at room temperature or in a heated environment (e.g., at between about 40° C. to about 80° C., typically at about 65° C.) until all moisture and/or water evaporates (i.e., dehydration), leaving behind dried reagent spots 150.

In another example, in a bulk manufacturing environment using a freeze-drying process (i.e., lyophilization), bottom substrate 120 with the “spots” of reagent solution is held at cold temperature (e.g., at between about −80° C. to about −10° C., typically at about −50° C.) until all ice is removed by sublimation, leaving behind dried reagent spots 150.

In yet another example, in a single-device manufacturing environment using an evaporative drying process, bottom substrate 120 with the droplet of reagent solution may sit out at room temperature or in a heated environment (e.g., at between about 40° C. to about 80° C., typically at about 65° C.) until all moisture and/or water evaporates (i.e., dehydration), leaving behind the dried reagent spot 150.

In still another example, in a single-device manufacturing environment using a freeze-drying process (i.e., lyophilization), bottom substrate 120 with the droplet of reagent solution is held at cold temperature (e.g., at between about −20° C. to about −80° C., typically at about −40° C.) until all ice is removed by sublimation, leaving behind the dried reagent spot 150.

At a step 325, the assembly of the active surface device(s) is completed. For example, in both the bulk manufacturing environment and single-device manufacturing environment, the active surface device(s) 100 may be formed or assembled according to the process described in U.S. Patent App. No. 62/522,536, entitled “Modular Active Surface Devices for Microfluidic Systems and Methods of Making Same,” filed on Jun. 20, 2017.

At an optional step 330, a quality control analysis process may be performed with respect to, for example, speed of mixing and homogeneity. For example, in the bulk manufacturing environment a sample of one or more active surface devices 100 may be pulled from the batch and analyzed.

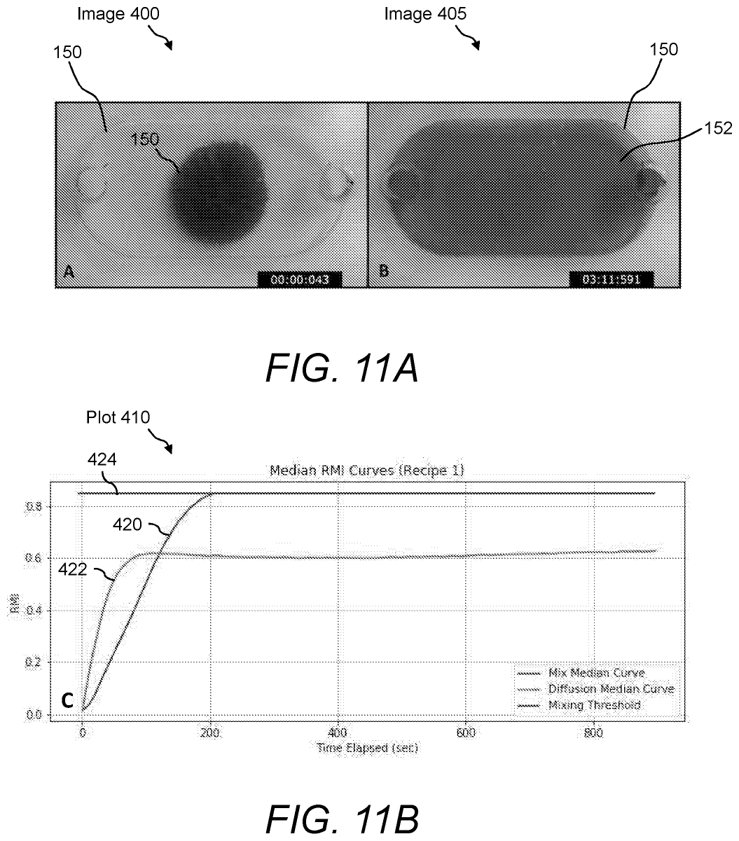

By way of example, FIG. 11A and FIG. 11B illustrate an example of a dye mixing test that can be performed as a quality control step. FIG. 11A shows images of reagent before and after rehydrating using active mixing in the presently disclosed active surface devices 100. For example, an image 400 shows a dried reagent spot 150 including blue indicator dye in reaction chamber 105. An image 405 shows a rehydrated and fully mixed reagent solution 152 (i.e., per rehydrated dried reagent spot 150) that is well distributed throughout reaction chamber 105 via the mixing action of micropost active surface layer 110. For example, via the mixing action of microposts 112 actuated using actuation mechanism 170 (see FIG. 5B and FIG. 7B). Additionally, FIG. 11B shows a plot 410 indicating the mixing efficiency of the presently disclosed active surface devices 100. For example, plot 410 is a plot of the relative mixing index (RMI) (or any other mixing measure, e.g., “absolute mixing index”) for cases with and without active mixing. Plot 410 shows a mix median curve 420, a diffusion median curve 422, and a mixing threshold line 424. The higher values of mix median curve 420 compared with diffusion median curve 422 indicate better mixing using micropost active surface layer 110 as compared with using diffusion alone.

At a step 335, the active surface device(s) 100 holding dried reagent are placed into storage. For example, the loading ports 107 of the reaction chamber(s) 105 holding dried reagent spot(s) 150 are sealed. Then, the active surface device(s) 100 holding dried reagent spot(s) 150 are placed into storage and held, in one example, at about room temperature or, in another example, at a cold temperature (e.g., at between about −20° C. to about 4° C.).

Referring still to method 300 shown in FIG. 9, the steps of method 300 may be modified according to any configurations of active surface device 100, such as, but not limited to, those configurations shown hereinabove with reference to FIG. 8A through FIG. 8F.

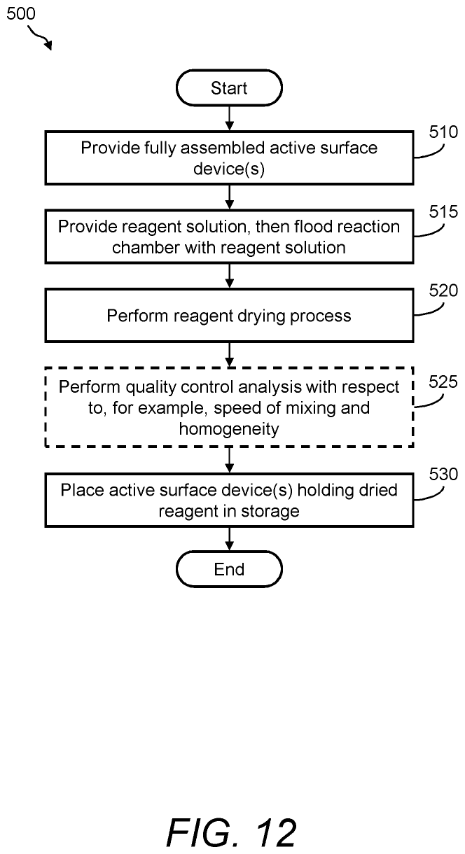

FIG. 12 illustrates a flow diagram of an example of a method 500 of forming a dried reagent coating (e.g., dried reagent coating 160) in the presently disclosed active surface devices for providing dried reagents in microfluidic applications. In one example, method 500 may be performed in a bulk manufacturing environment, which is represented by mask layer sheet 130′ shown in FIG. 10A for forming active surface devices 100 in bulk. In another example, method 500 may be performed at a single-device level. In this example, method 500 may be used to form individual active surface devices 100, such as the single active surface device 100 shown in FIG. 10B. The single active surface device 100 shown in FIG. 10B is representative of mask layer sheet 130′ shown in FIG. 10A after dicing. Method 500 may include, but is not limited to, the following steps.

At a step 510, fully assembled the active surface device(s) 100 are provided. In one example, in a bulk manufacturing environment, a sheet of fully assembled the active surface device(s) 100 are provided, as represented by, for example, mask layer sheet 130′ shown in FIG. 10A. In another example, in a single-device manufacturing environment, a single active surface device 100 is provided, such as the single active surface device 100 shown in FIG. 10B. Additionally, in both cases, the loading ports 107 of the reaction chamber(s) 105 are not yet sealed.

At a step 515, the reagent solution is provided, then the reaction chamber(s) 105 of the active surface device(s) 100 are flooded with reagent solution. For example, reagent solution may be provided according to the formulations shown hereinabove with reference to Table 1, such as “Reagent/Protein Stabilizer Recipe 1,” “Reagent/Protein Stabilizer Recipe 2,” “Reagent/PCR Mastermix Stabilizer Recipe 1,” and “Reagent/PCR Mastermix Stabilizer Recipe 2.” Then, using loading ports 107, the reaction chamber(s) 105 of the active surface device(s) 100 are flooded with the reagent solution.

At a step 520, a reagent drying process is performed. In one example, in both the bulk manufacturing environment and the single-device manufacturing environment using an evaporative drying process, the active surface device(s) 100 holding the reagent solution are held at room temperature or in a heated environment (e.g., at between about 40° C. to about 80° C., at typically about 65° C.) until all moisture and/or water evaporates (i.e., dehydration) from the reaction chamber(s) 105 via loading ports (or vents) 107, leaving behind dried reagent coating 160 on substantially all surfaces of the reaction chamber(s) 105 (including microposts 112).

In another example, in both the bulk manufacturing environment and the single-device manufacturing environment using a freeze-drying process (i.e., lyophilization), the active surface device(s) 100 holding the reagent solution are held at cold temperature (e.g., at between about −80° C. to about −10° C., typically at about −50° C.) until all ice is removed by sublimation from the reaction chamber(s) 105 via loading ports (or vents) 107, leaving behind dried reagent coating 160 on substantially all surfaces of the reaction chamber(s) 105 (including microposts 112).

At an optional step 525, a quality control analysis process may be performed with respect to, for example, speed of mixing and homogeneity. For example, in the bulk manufacturing environment a sample of one or more active surface devices 100 may be pulled from the batch and analyzed. By way of example and referring again to dried reagent spot 150 and the rehydrated and fully mixed reagent solution 152 shown in FIG. 11A and to plot 410 shown in FIG. 11B, the higher values of mix median curve 420 compared with diffusion median curve 422 indicate better mixing using micropost active surface layer 110 as compared with diffusion alone.

At a step 530, the active surface device(s) 100 holding dried reagent are placed into storage. For example, the loading ports 107 of the reaction chamber(s) 105 coated with the dried reagent coating 160 are sealed. Then, the active surface device(s) 100 holding the dried reagent coating 160 are placed into storage and held, in one example, at about room temperature or, in another example, at a cold temperature (e.g., at between about −20° C. to about −4° C., most commonly).

Referring still to method 500 shown in FIG. 12, the steps of method 500 may be modified according to any configurations of active surface device 100, such as, but not limited to, those configurations shown hereinabove with reference to FIG. 8A through FIG. 8F.

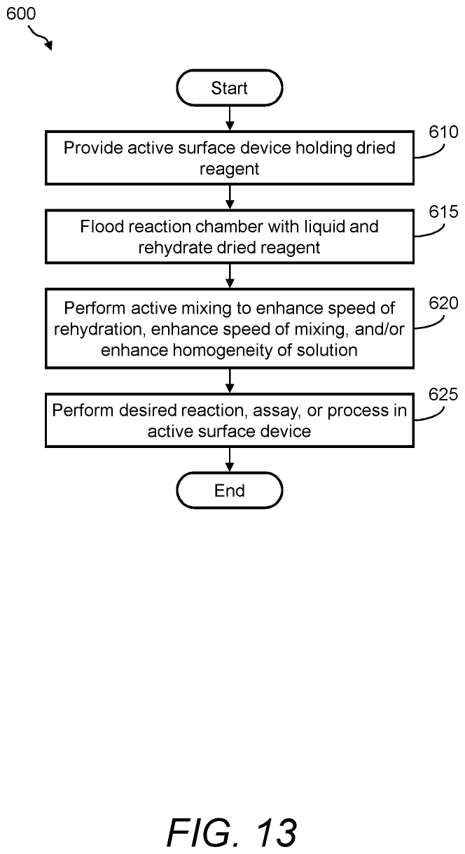

FIG. 13 illustrates a flow diagram of an example of a method 600 of using the presently disclosed active surface devices 100 for providing dried reagents in microfluidic applications. Method 600 may include, but is not limited to, the following steps.

At a step 610, active surface device 100 holding dried reagent are provided. In one example, an active surface device 100 holding at least on dried reagent spot 150 is provided, such as the active surface device 100 shown in FIG. 4A, FIG. 4B, FIG. 5A, and FIG. 5B. In another example, an active surface device 100 holding dried reagent coating 160 is provided, such as the active surface device 100 shown in FIG. 6A, FIG. 6B, FIG. 7A, and FIG. 7B.

At a step 615, reaction chamber 105 of the active surface device 100 is flooded with a rehydration solution, such as, but not limited to, buffer solution, DI water, and the like.

At a step 620, active mixing is performed to enhance speed of rehydration and/or homogeneity of solution. For example, actuation mechanism 170 (see FIG. 5B and FIG. 7B) is activated. In doing so, microposts 112 of micropost active surface layer 110 are actuated to provide active mixing in reaction chamber 105 of the active surface device 100. This active mixing action of micropost active surface layer 110 is used to enhance speed of rehydration, enhance speed of mixing, and/or enhance the homogeneity of solution.

At a step 625, the desired reaction, assay, or process is performed in active surface device 100.

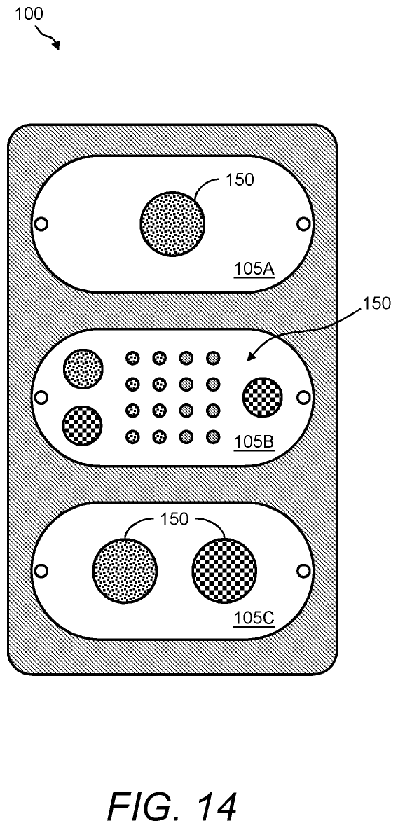

FIG. 14 illustrates a plan view of an example of active surface device 100 that may include multiple reaction (or assay) chambers 105 and wherein any reaction chamber 105 may include one or multiple dried reagent spots 150. Additionally, any reaction chamber 105 may include different types of dried reagent spots 150. In this example, active surface device 100 includes three reaction chambers 105 (e.g., 105A, 105B, 105C). Reaction chamber 105A includes one dried reagent spot 150. Reaction chamber 105B includes multiple dried reagent spots 150 of different types, sizes, and arrangements. Reaction chamber 105C includes two dried reagent spots 150 of different types. In this example, the three reaction chambers 105 can be plumbed separately or can have fluidic connections therebetween.

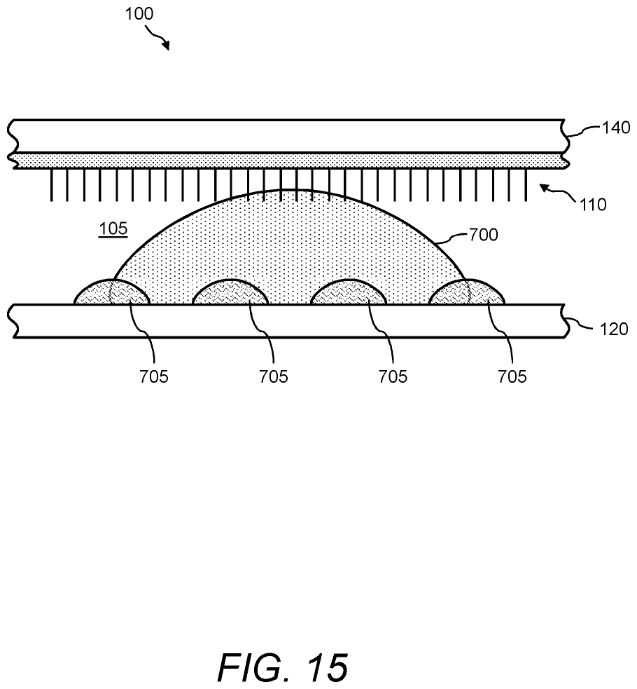

FIG. 15 illustrates a cross-sectional view of an example of a process of depositing multiple dried reagent spots 150. FIG. 15 shows an example of a geometry of reagent deposition that may be used for reducing interference of the dried reagent spots 150 with microposts 112. For example, a large reagent droplet 700 is deposited atop bottom substrate 120. Then, large reagent droplet 700 is broken up into multiple small reagent droplets 705. In one example, a spotter may be used to break up the large reagent droplet 700. Examples of spotters include non-contact fluid dispensing systems available from BioDot (Irvine, Calif.) or SCIENION AG (Berlin, Germany).

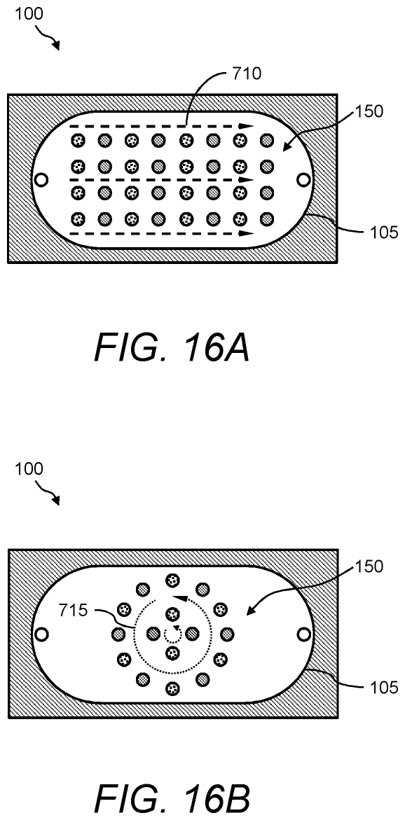

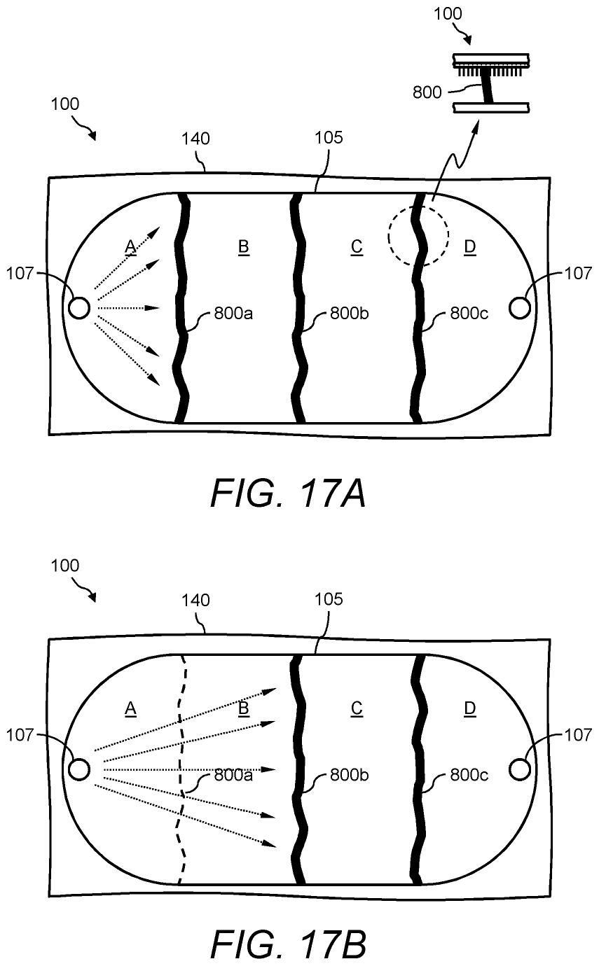

FIG. 16A and FIG. 16B illustrate plan views of examples of multiple dried reagent spots 150 deposited in patterns that correspond to the mixing action of microposts 112 of micropost active surface layer 110 for maximizing the interaction of the reagents. For example, FIG. 16A shows multiple dried reagent spots 150 deposited across the floor of reaction chamber 105 in a pattern such that the mixing action of microposts 112 (indicated by dotted lines 710) maximize the interaction of the reagents as they come in contact. This example requires matching the deposition pattern with the mixing pattern. For example, a grid pattern of dried reagent spots 150 could be matched with unidirectional pumping, as shown in FIG. 16A. In another example, FIG. 16B shows a circular pattern of dried reagent spots 150 that could be matched with vertical pumping action (indicated by dotted lines 715).

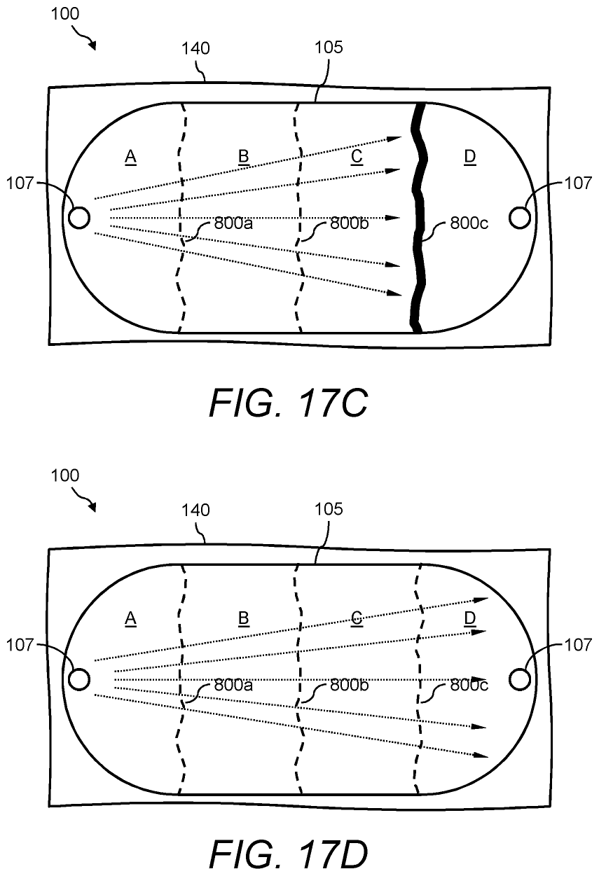

FIG. 17A, FIG. 17B, FIG. 17C, and FIG. 17D illustrate plan views of an example of dried inert reagent barriers 800 in reaction (or assay) chamber 105 of active surface device 100 and a valving process for staging flow. For example, reaction chamber 105 is segmented into four regions (A, B, C, D) via three dried inert reagent barriers 800 (e.g., 800a, 800b, 800c). Each dried inert reagent barrier 800 forms a wall between bottom substrate 120 and micropost active surface layer 110.

Dried inert reagent barriers 800 are formed of inert reagents that are dissolvable at a controlled rate. Accordingly, dried inert reagent barriers 800 can be used as a valving mechanism in active surface device 100. For example, FIG. 17A shows fluid entering region A and being contained in region A by dried inert reagent barrier 800a. Next and referring now to FIG. 17B, after a certain amount of time the dried inert reagent barrier 800a dissolves and allows fluid flow to continue into region B. The fluid is now contained against dried inert reagent barrier 800b. Next and referring now to FIG. 17C, after a certain amount of time the dried inert reagent barrier 800b dissolves and allows fluid flow to continue into region C. The fluid is now contained against dried inert reagent barrier 800c. Next and referring now to FIG. 17D, after a certain amount of time the dried inert reagent barrier 800c dissolves and allows fluid flow to continue into the entire reaction chamber 105. In this example, dried inert reagent barriers 800a, 800b, and 800c act as single use valves.

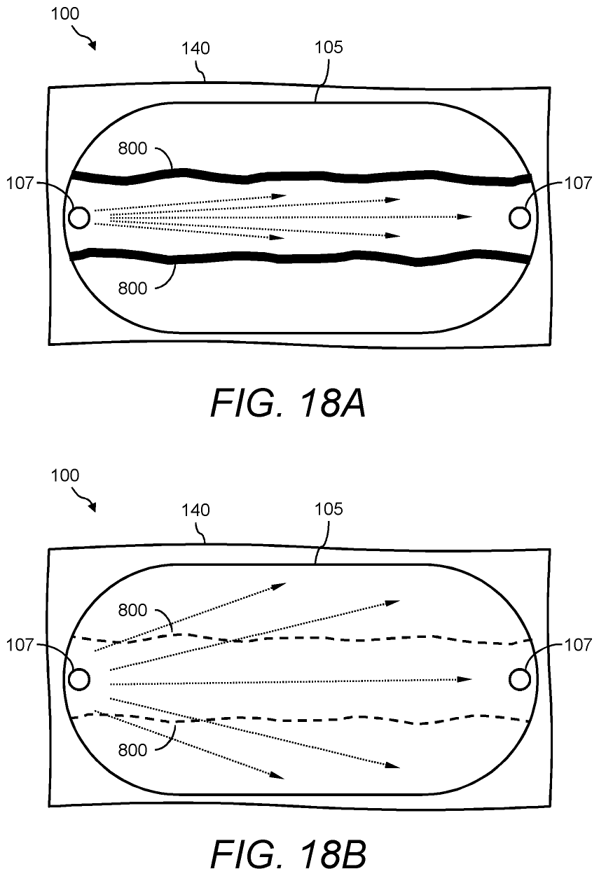

FIG. 18A and FIG. 18B illustrate plan views of an example of dried inert reagent barriers 800 in reaction (or assay) chamber 105 of active surface device 100 for directing flow. In this example, two dried inert reagent barriers 800 are provided in parallel along the length of reaction chamber 105 from one loading port 107 to the other. These two dried inert reagent barriers 800 define a narrow flow path as compared with the full width of reaction chamber 105. These two dried inert reagent barriers 800 provide a temporary alternative flow path through reaction chamber 105. For example, FIG. 18A shows fluid entering the space between two dried inert reagent barriers 800 and flowing along this channel from one end of reaction chamber 105 to the other. Next and referring now to FIG. 18B, after a certain amount of time the two dried inert reagent barriers 800 dissolve, which allows fluid flow to expand across the full area of reaction chamber 105.

Using the concepts of providing temporary barriers formed of inert reagent material in a reaction chamber various other functions are possible in active surface device 100. For example, instead of patterning multiple reaction chambers 105 in active surface device 100 and the fluidics cartridge managing the flow from one to another, pattern just one reaction chamber 105 and then form multiple chambers in the one reaction chamber 105 using the dissolvable inert reagents. Any placement of inert reagents for form barriers or walls is possible. Additionally, the temporary barriers are not limited to dissolvable barriers. In another example, the temporary barriers may be broken down or compromised via heat.

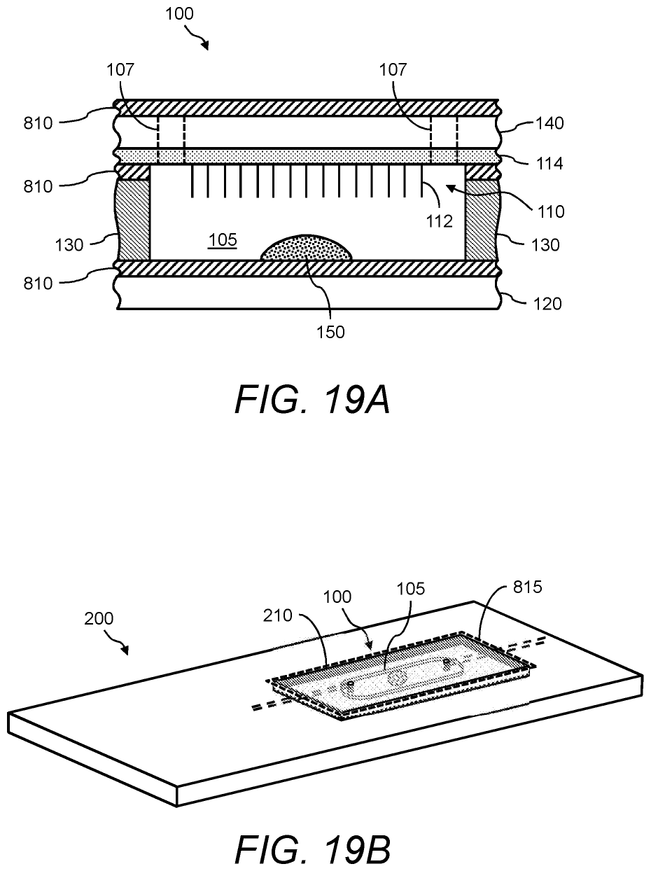

FIG. 19A and FIG. 19B illustrate a cross-sectional view and a perspective view, respectively, of an example of the presently disclosed active surface device 100 including dried reagent and including vapor barrier mechanisms. In this example, certain vapor barrier layers 810 may be integrated into the structure of active surface device 100. Vapor barrier layers 810 can be, for example, foil layers. For example, FIG. 19A shows a vapor barrier layer 810 between bottom substrate 120 and mask layer 130. Another vapor barrier layer 810 is provided between mask layer 130 and micropost active surface layer 110. Another vapor barrier layer 810 is provided atop active surface substrate 140 and sealing loading ports 107. FIG. 19B shows other sealing material 815 can be applied around the perimeter of active surface device 100 after being installed in fluidics cartridge 200.

The active surface device 100 including dried reagent and including vapor barrier mechanisms, as shown in FIG. 19A and FIG. 19B, is useful to maintain substantially complete isolation of dried reagents inside active surface device 100 from sources of liquid (e.g., wet blister packs) that may exist elsewhere on the fluidics cartridge/system.

Although the foregoing subject matter has been described in some detail by way of illustration and example for purposes of clarity of understanding, it will be understood by those skilled in the art that certain changes and modifications can be practiced within the scope of the appended claims.

1. A microfluidic reaction chamber comprising:
a. a housing enclosing a chamber;
b. an active surface situated in the chamber, the active surface comprising a dried reagent deposited thereon; and
c. an opening suitable for flowing a liquid into and/or out of the microfluidic reaction chamber.

2. (canceled)

3. The microfluidic reaction chamber of claim 1, wherein the active surface comprises a micropost active surface layer, and wherein the dried reagent coats some or all of the microposts.

4. The microfluidic reaction chamber of claim 1, wherein the dried reagent comprises one or more spots of dried reagent, and wherein the dried reagent coats a surface of the reaction chamber.

5.-6. (canceled)

7. The microfluidic reaction chamber of claim 1 comprising a liquid in the chamber rehydrating the dried reagent.

8. An instrument comprising:
a. the microfluidic reaction chamber of claim 1; and
b. an actuator arranged relative to the active surface of the active surface device in a spatial relationship which permits the actuator to actuate the active surface.

9. A microfluidic cartridge comprising the microfluidic reaction chamber of claim 1 fitted into a recessed region within a microfluidic cartridge, thereby causing fluid coupling between the opening and the microfluidic cartridge.

10. An instrument comprising:
a. the microfluidic cartridge of claim 9; and
b. an actuator arranged relative to the active surface of the active surface device of the microfluidic cartridge in a spatial relationship which permits the actuator to actuate the active surface.

11. A method of providing a microfluidic reaction chamber comprising:
a. providing an active surface;
b. drying a reagent on the active surface;
c. situating the active surface in a chamber housing, wherein the chamber housing comprises an opening suitable for flowing a liquid into and/or out of the microfluidic reaction chamber.

12. The method of claim 11, wherein the method further comprises layering a mask layer on the active surface prior to drying the reagent on the active surface.

13. The method of claim 11, wherein drying the reagent comprises depositing reagent droplets on the active surface and drying the droplets.

14. The method of claim 11, wherein drying the reagent produces multiple dried reagent spots on the active surface or produces a coating on the active surface, and wherein drying the reagent is effectuated via an evaporative drying process or via a freeze-drying process.

15. (canceled)

16. The method of claim 11, wherein step c. is performed prior to step b. and the method further comprises drying a reagent on an inner surface of the chamber housing.

17.-18. (canceled)

19. A method of rehydrating a dried reagent for use in a microfluidic application comprising the steps of:
a. providing the microfluidic reaction chamber of claim 1 wherein the active surface comprises a micropost layer;
b. flowing a rehydration solution into the reaction chamber;
c. activating the active surface to cause the dried reagent to mix with the rehydration solution; and
d. performing a reaction, assay, or process on the active surface.

20. A method of rehydrating a dried reagent for use in a microfluidic application comprising the steps of:
a. providing the microfluidic reaction chamber by the method of claim 11 wherein the active surface comprises a micropost layer;
b. flowing a rehydration solution into the reaction chamber;
c. activating the active surface to cause the dried reagent to mix with the rehydration solution; and
d. performing a reaction, assay, or process on the active surface.

21. (canceled)

22. The method of claim 19, wherein the rehydration solution is flowed into the microfluidic reaction chamber via the opening, and wherein the rehydration solution comprises a buffer solution or deionized water.

23.-24. (canceled)

25. The method of claim 19, wherein the microposts are substantially coated with one or more dried reagents, and wherein the dried reagent is selected from a group consisting of cell lysis reagents, PCR reagents, proteins, antibodies, labels, stabilizers, and magnetic and non-magnetic beads.

26. The microfluidic reaction chamber of claim 1, wherein the microfluidic reaction chamber is separated by one or more dissolvable dried reagent barriers, wherein the dried reagent barriers comprise an inert reagent, and wherein the dried inert reagent barrier is dissolvable at a controlled rate, thereby acting as a valving mechanism within the active surface device.

27. (canceled)

28. The microfluidic reaction chamber of claim 26 comprising two or more of the dried inert reagent barriers dissolvable at different rates.

29.-30. (canceled)

31. The method of claim 20, wherein the rehydration solution is flowed into the microfluidic reaction chamber via the opening, and wherein the rehydration solution comprises a buffer solution or deionized water.

32. The method of claim 20, wherein the microposts are substantially coated with one or more dried reagents, and wherein the dried reagent is selected from a group consisting of cell lysis reagents, PCR reagents, proteins, antibodies, labels, stabilizers, and magnetic and non-magnetic beads.
